(19) United States
(12) Patent Application Publication
(10) Pub. No.: US 2023/0390698 A1
(43) Pub. Date: Dec. 7, 2023

(54) METHANE OXIDATION DEVICE

(71) Applicant: ZELP LTD, London (GB)

(72) Inventors: Francisco NORRIS, London (GB); Patricio NORRIS, London (GB); Thomas GUNDRY, London (GB); Christopher JONES, London (GB)

(73) Assignee: ZELP LTD, London (GB)

(21) Appl. No.: 18/453,225

(22) Filed: Aug. 21, 2023

Related U.S. Application Data
(63) Continuation of application No. PCT/GB2022/050458, filed on Feb. 21, 2022.

(30) Foreign Application Priority Data
Feb. 23, 2021 (GB) 2102535.8

(51) Int. Cl. B01D 53/34; B01D 53/86; B01J 19/24; A01K 25/00

(52) U.S. Cl. CPC B01D 53/343; B01D 53/864; B01J 19/24; A01K 25/00; B01J 2219/00155; B01D 2258/0266; B01D 2257/7025

(57) ABSTRACT

A methane oxidation device for recovering heat for re-use in oxidation, the methane oxidation device comprising; a methane oxidation unit for oxidising methane; and a heat exchanger for recovering heat for re-use in oxidation; wherein the heat exchanger comprises; an inlet arranged, in use, in fluid communication with a source of methane emissions; an outlet; at least one flow path, the at least one flow path fluidly connecting the inlet to the outlet, the at least one flow path having at least a portion passing though the methane oxidation unit; and at least one counter flow path, wherein the counter flow path is the counter of the flow path, the at least one counter flow path having at least a portion passing though the methane oxidation unit; in use, the at least one flow path and counter flow path are arranged to permit heat transfer therebetween.

### CROSS REFERENCE TO RELATED APPLICATIONS

This continuation application claims priority benefit from International Application No. PCT/GB2022/050458 filed on Feb. 21, 2022, which claimed priority from Great Britain Application No. 2102535.8 filed Feb. 23, 2021, which are incorporated herein by reference in their entireties.

### FIELD OF THE INVENTION

The present invention relates to a methane oxidation device for recovering heat for re-use in oxidation.

### BACKGROUND OF THE INVENTION

Methane is known to be a potent greenhouse gas, having a global warming potential that is considerably higher than that of carbon dioxide. Livestock are known to be a significant source of methane gas, which is released via exhalation and eructation. The methane emission of livestock often has direct economic consequences for livestock producers, who may be subject to taxes based on their carbon footprint. Additionally, with cattle being key contributors to global warming, it is vital to reduce methane emissions from livestock.

A method of reducing the quantity of methane emissions is to capture and oxidise the methane before it is released into the atmosphere. In this process, methane is oxidised with oxygen to produce carbon dioxide and water vapour, reducing the quantity of harmful methane released. The energy demand of this process is high, with a required oxidation temperature of around 500° C. Additionally, recurrent emissions from livestock mean that the need to oxidise this methane arises very frequently.

As such, there is a need for a means to recover the energy from the methane oxidation and reuse this energy in the oxidation process.

Objects and aspects of the present invention seek to alleviate at least these problems with the prior art.

### SUMMARY OF THE INVENTION

According to a first aspect of the invention, there is provided a methane oxidation device for recovering heat for re-use in oxidation, the methane oxidation device comprising; a methane oxidation unit for oxidising methane; and a heat exchanger for recovering heat for re-use in oxidation; wherein the heat exchanger comprises; an inlet arranged, in use, in fluid communication with a source of methane emissions; an outlet; at least one flow path, the at least one flow path fluidly connecting the inlet to the outlet, the at least one flow path having at least a portion passing though the methane oxidation unit; and at least one counter flow path, wherein the counter flow path is the counter of the flow path, the at least one counter flow path having at least a portion passing though the methane oxidation unit; in use, the at least one flow path and counter flow path are arranged to permit heat transfer therebetween.

In this way, energy from the oxidation of methane emissions can be recovered and reused within the oxidation process. As such, the reliance on any external power source for this process can be reduced or nullified. This heat recovery allows a self-sustaining methane oxidation device to be provided, with a reduced weight and thus improved portability. Such a device is advantageous, in particular, in applications wherein the device is mounted to livestock or another animal to capture and oxidise methane emissions released by the animal.

Preferably, in use, fluid flows via the at least one flow path and the at least one counter flow path and heat from the fluid exiting the methane oxidation unit is transferred to heat the fluid entering the methane oxidation unit. In this way, the unheated fluid entering the methane oxidation unit is heated ahead of oxidation and the heated fluid exiting the methane oxidation unit is cooled before release into the external environment. Such a process recovers heat from the oxidation process and reuses it by heating the fluid to be oxidised ahead of oxidation.

In some embodiments, the heat exchanger is a plate heat exchanger. Alternatively, or additionally, the heat exchanger is a recuperative heat exchanger. Alternatively, the heat exchanger is a regenerative heat exchanger. Preferably, the heat exchanger is a single pass heat exchanger. Alternatively, the heat exchanger is a double pass heat exchanger.

Preferably, the inlet comprises an inlet manifold and the outlet comprises an outlet manifold. In this way, the device comprises a plurality of flow paths and a plurality of counter flow paths allowing for an efficient and high rate of heat transfer from one path to another, while minimising the pressure drop and heat losses through the methane oxidation device.

Preferably, the at least one counter flow path is parallel to the at least one flow path. In this way, a parallel flow heat exchanger is provided and the resistance to heat transfer between the flow path and counter flow path, and vice versa, is substantially identical along the length of the flow path and counter flow path.

Preferably, the length of the at least one flow path is identical to the length of the at least one counter flow path. Preferably, the at least one flow path and the at least one counter flow path are substantially straight. Alternatively, the at least one flow path and the at least one counter flow path are substantially curved or U-shaped.

Preferably, the methane oxidation unit comprises a chamber for catalytic oxidation of methane. The catalytic oxidation chamber oxidises the methane present from the animal exhalations in an exothermic manner releasing energy into the fluid stream. Alternatively, or additionally, the methane oxidation unit comprises at least one catalytic material located within the heater exchanger. In some embodiments, the at least one catalytic material is located within at least one of the at least one flow path or the at least one counter flow path. In this way, oxidation of the methane occurs within the heat exchanger, removing the need for a separate oxidation chamber.

Preferably, the methane oxidation unit is located substantially equidistant the length of the at least one flow path and the at least one counter flow path. In this way, there is equal capacity for heat transfer between the flow path and counter flow path and vice versa, for example when heat from the fluid exiting the methane oxidation unit is transferred to heat the fluid entering the methane oxidation unit.

Preferably, the heat exchanger comprises an insulation unit for insulating the device to reduce heat loss to the external environment. Reducing heat loss to the external environment increases the quantity of heat that can be recovered and reused within the oxidation process.

In some embodiments, the device comprises a plurality of heat exchangers. The heat exchangers may be configured with two or more in series, with the inlet of one heat exchanger feeding into the outlet of another heat exchanger, reducing the pressure loses due to any piping and fitting requirements and increasing the heat transfer efficiency.

In some embodiments, the device comprises a heater unit for heating fluid within the methane oxidation unit, in use. Animal methane emissions require heating from their exhalation temperature of around 30° C. to an oxidation temperature of around 500° C. In preferred embodiments, no heater unit is required by the device and the heat recovered and reused by the device is sufficient to heat the animal emissions to the required temperature for oxidation, in use. In this way, the device is substantially self-sustaining and reliance on a power source for powering the heat unit is removed. Alternatively, reliance on a heater unit by the device is periodic and therefore the power demand from any power source is reduced.

Preferably, the device is substantially cuboid. Alternatively, the device is substantially V-shaped. Alternatively, the device is substantially curved or U-shaped. In this way, the shape of the device is suited to the location of the device, in use. Such a feature reduces the bulk of the device on the animal, in use, helping to prevent the device from interfering with the animal's vision, feed or water intake, rumination or other normal behaviour.

Preferably, the device comprises a connection means for connecting the inlet to a methane collection unit. Preferably, the connection means are configured to minimise the distance travelled by a fluid between the inlet and a methane collection unit. In this way, there is a recued need for a pump or external fluid movement device to assist the flow of fluid between a methane collection unit and the methane oxidation device.

In some embodiments, the device comprises a methane collection unit for collecting methane emissions emitted by an animal. Preferably, in use, the methane collection unit is located proximate the snout of an animal for collecting methane emissions of the animal. Preferably, the methane collection unit is configured to reduce dilution or pre-dispersion of the animal's exhalation prior to collection by the methane collection unit. Preferably, the methane collection unit comprises at least one sensor for detecting at least one characteristic of an animal's emissions. For example, the methane collection unit may comprise a methane sensor, carbon dioxide sensor and/or temperature sensor.

In some embodiments, the device comprises positioning means for positioning the device proximate the head of an animal. In this way, the device can be securely mounted to an animal proximate a source of the animal's methane emissions, for example, but not limited to, mounted on the animals' shoulders, neck or head. Alternatively, the device comprises mounting means for mounting the device on a harness of an animal. In this way, the device can be used alongside existing equipment carried by the animal. Both configurations allow the device to be removably retained on the animal, such that the device may be removed, for example, for maintenance. In other embodiments, the device comprises positioning means for positioning the device on a stationary structure. For example, the device may comprise positioning means for mounting the device, in use, proximate a feedlot, stable, barn or other suitable location where methane emissions are present. In this way, methane emissions from multiple animals can be oxidised by the device simultaneously. In such embodiments, the device may comprise a methane collection unit configured to collect methane emissions from the external environment. In some embodiments, the methane oxidation device is configured for both stationary use on a structure and portable use on an animal.

Preferably, the device comprises at least one sensor. For example, the methane oxidation device may comprise a methane sensor, carbon dioxide sensor, inertia sensor, pressure sensor, flow rate sensor and/or temperature sensor. In this way, at least one characteristic of the animal emission characteristics, oxidation conditions or flow characteristics can be detected and monitored by the user.

In some embodiments, the device comprises a pump for assisting fluid flow through the device, in use. The type of pump is not particularly limited, and the device may comprise any suitable pump or fluid movement device, such as a centrifugal pump. Preferably, the heat exchanger is configured to have a very low pressure drop along each flow path. In this way, the need for a pump or external fluid movement device is reduced or eliminated, reducing the power requirements of the device.

Preferably, the device comprises an emission separator unit for, in use, separating the emissions based on at least one emission characteristic. Preferably, the at least one emission characteristic is methane purity. Preferably, the device is configured such that, in use, emissions are separated prior to entering the heat exchanger. In this way, the methane emissions can be filtered such that have low-purity emissions bypass the heat exchanger and high-purity exhalations enter the heat exchanger. In some embodiments, the device comprises a valve in fluid communication with the external environment. In this way, the device may be configured such that all exhalations with a methane purity below a certain level bypass the exchanger via a valve, and those over that level flow into the heat exchanger, in use. Separating the emissions by methane purity reduces the quantity of low-methane emissions undergoing oxidation, consequently improving energy generation from the oxidation process and reducing the quantity of undesirable cooling of fluid prior to oxidation.

### BRIEF DESCRIPTION OF THE DRAWINGS

The accompanying drawings, which are incorporated in and constitute a part of the specification, illustrate embodiments of the disclosure and together with the detailed description herein, serve to explain the principles of the disclosure. It is emphasized that, in accordance with the standard practice in the industry, various features are not drawn to scale. In fact, the dimensions of the various features may be arbitrarily increased or reduced for clarity of discussion. The drawings are only for purposes of illustrating preferred embodiments and are not to be construed as limiting the disclosure:

FIG. 1 depicts a perspective view of the methane oxidation device in accordance with the present invention positioned on the head of a cow, in use;

FIG. 2 depicts a deconstructed view of the methane oxidation device of FIG. 1 positioned on the head of a cow, in use;

FIG. 3 depicts a second embodiment of the methane oxidation device of FIG. 1 positioned on the head of a cow, in use;

FIG. 4 depicts a deconstructed view of the first embodiment of the methane oxidation device of FIG. 1;

FIG. 5 depicts a deconstructed view of a third embodiment of the methane oxidation device of FIG. 1; and

FIG. 6 depicts the flow path and counter flow path of the methane oxidation device of the first embodiment of FIG. 1.

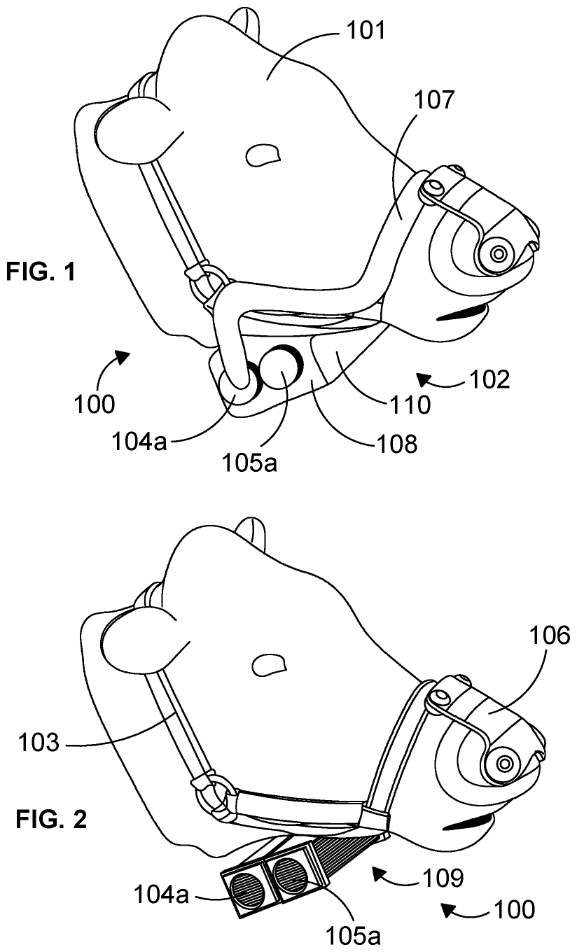

With reference to FIG. 1 and FIG. 2, there is illustrated a methane oxidation device 100 for recovering heat for re-use in oxidation, in use, mounted on the head of a cow 101. While the below embodiments outline use of the methane oxidation device 100 on a cow 101, it in envisaged that the device 100 of the present invention may be used on other bovine and non-bovine animals, such as sheep and goats. In this way, the device 100 is not limited to use on cattle.

The methane oxidation device 100 comprises a body member 102 comprising an insulating housing 110. Located within the insulating housing 110, the body member 102 comprises a methane oxidation unit for oxidising methane and a heat exchanger 109 for recovering heat for re-use in oxidation. FIG. 2 illustrates a deconstructed version of the body member 102 with the insulating housing 110 removed. The insulating housing 110 comprises an insulating unit for insulating the device 100 to reduce heat loss to the external environment. The insulating unit comprises any one or more suitable insulation materials, apparatus or structures to reduce heat loss from the body member 102 to the external environment of the methane oxidation device. For example, the insulating unit may comprise mineral wool insulation, aerogel, expanded foam, fibreglass insulation, polystyrene insulation and/or multi-layered aluminium.

The methane oxidation device 100 comprises positioning means 103 such that, in use, the body member 102 is positioned proximate the head of the cow 101. In this embodiment, the positioning means 103 comprises a plurality of straps for securing the methane oxidation device 100 to the underside of the head of the cow 101.

The body member 102 is substantially cuboid and comprises a first inlet 104a and a first outlet 105a located on a first surface 108 of the body member 102. The first inlet 104a is arranged, in use, in fluid communication with an external methane collection unit 106 via connection means. In this embodiment, the connection means comprises an elongate member 107. The methane collection unit 106 is positioned on the snout of the cow 101, in use, such that emissions released from the snout are collected by the methane collection unit 106. The elongate member 107 passes along the head of the cow 101 from the methane collection unit 106 to the body member 102 where it connects to the first inlet 104a. The methane oxidation device 100 is configured such that it does not interfere with the cow's 101 vision, feed or water intake, rumination or other normal behaviour.

The methane oxidation device 100 further comprises a second inlet adjacent a second outlet located on a second surface (not pictured) of the body member 102. The second surface is located on the surface of the body member 102 distal the first surface 108. In use, the first outlet 105a is located between the first inlet 104a and the snout of the cow 101 on the first surface 108 and on the second surface, the second inlet is located between the second outlet and the snout of the cow 101.

The second inlet is also in fluid communication with the methane collection unit 106 via the elongate member 107, in a similar manner to the first inlet 104. In this way, the elongate member 107 extends along both sides of the cow's 101 head.

The methane oxidation device 100 further comprises an emission separator unit for, in use, separating the emissions based on methane purity. The device 100 is configured such that, in use, emissions are separated prior to entering the heat exchanger 109. The device 100 is configured such that all exhalations with a methane purity below 500 parts per million (ppm) bypass the exchanger, and those over 500 ppm flow into the heat exchanger, in use.

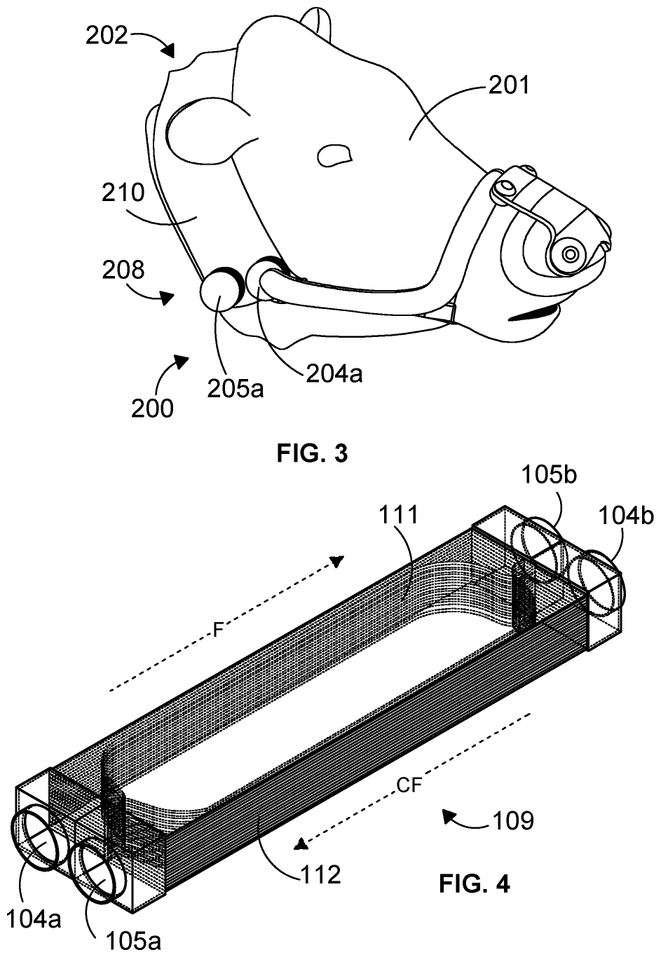

With reference to FIG. 3, a second embodiment of the methane oxidation device 200 is illustrated, in use, mounted on the head of a cow 201. In the following description, similar numerals will be used for similar parts of an embodiment of the present invention.

The methane oxidation device 200 comprises a substantially U-shaped body member 202 housing a substantially U-shaped heat exchanger. In this way, the body member 202 is located over the neck of the cow 101 and the weight of the methane oxidation device 200 is supported by the neck of the cow 101. The device 200 further comprises an insulating housing 210.

In this embodiment, the methane oxidation device 200 comprises a first inlet 204a and a first outlet 205a located in a first region 208 of the body member 202 and a second inlet and second outlet located in a second region (not pictured) of the body member 202. The first region 208 and the second region are located at distal ends of the body member 202. The first inlet 204a is located between the first outlet 205a and the snout of the cow 101 in the first region 208 and in the second region, the second outlet is located between the second inlet and the snout of the cow 201. The methane oxidation device 200 is configured such that it does not interfere with the cow's 201 vision, feed or water intake, rumination or other normal behaviour.

With reference to FIG. 4, the body portion comprises a heat exchanger 109 located within the insulating housing 110 of the methane oxidation device 100. The heat exchanger 109 comprises two paths, a flow path 111 with flow direction F and a counter flow path 112 with flow direction CF. The counter flow path 112 is the counter of the flow path 111.

The flow path 111 fluidly connects the first inlet 104a to the second outlet 105b such that, in use, fluid flows from the first inlet 104a to the second outlet 105b. The counter flow path 112 fluidly connects the second inlet 104b to the first outlet 105a such that, in use, fluid flows from the second inlet 104b to the first outlet 105a. In this way, the heat exchanger 109 is a single pass heat exchanger.

The counter flow path 112 is parallel to the flow path 111 and the length of the flow path 111 is identical to the length of the one counter flow path 112. In this embodiment, the flow path 111 and counter flow path 112 are substantially straight. In use, the flow path 111 and counter flow path 112 are arranged to permit heat transfer therebetween. The flow path 111 and counter flow path 112 are configured to promote equal and suitable flow through the heat exchanger 109. Further, the device 100 is configured to minimise undesirable characteristics of the fluid flowing within it, such as undesirable velocities, pressured drops, fouling and turbulence.

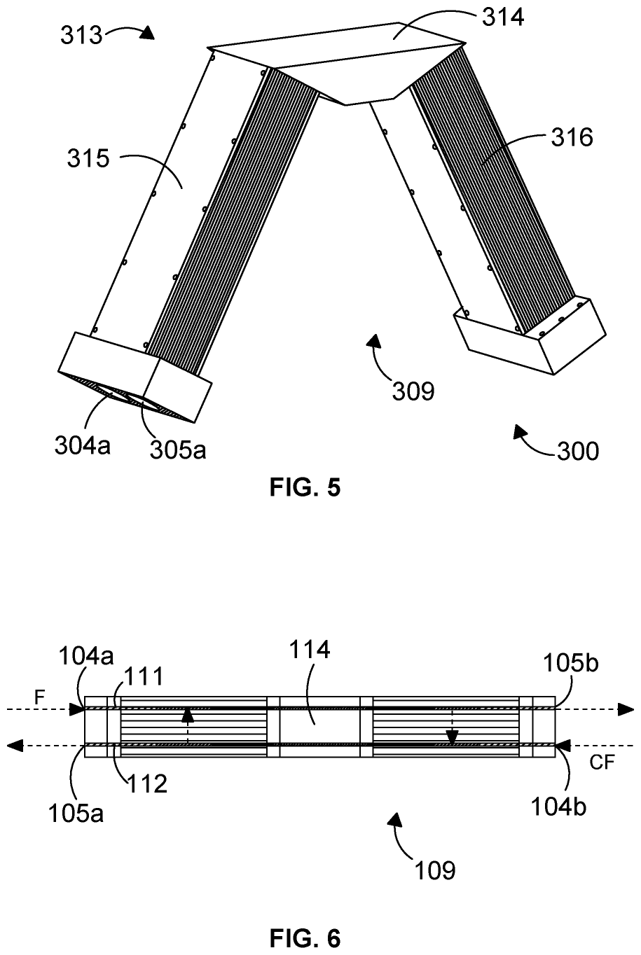

With reference to FIG. 5, there is illustrated a deconstructed view of a third embodiment of the methane oxidation device 300, wherein the device 300 is substantially V-shaped. The methane oxidation device 300 comprises a heat exchanger 309 comprising a first inlet 304a, first outlet 305a, second inlet, second outlet, flow path and counter flow path, similar to the embodiment of FIG. 4. The methane oxidation device further comprises a methane oxidation unit 313 comprising a chamber 314 for catalytic oxidation of methane.

The methane oxidation unit 313 is located substantially equidistant the length of the flow path and the one counter flow path. In this embodiment, the chamber 314 is located between a first straight portion 315 and a second straight portion 316, such that the first straight portion 315, chamber 314 and second straight portion 316 are in fluid communication. The flow path has a portion passing through the chamber 314 and the counter flow path has a portion passing through the chamber 314. In this way, in use, fluid flows from the first inlet 304a, through the first straight portion 315, into the chamber 314, through the second straight portion 316 and exits the device 300 via the first outlet. In a similar manner, in use, fluid flows from the second inlet, through the second straight portion 316, into the chamber 314, through the first straight portion 315 and exits the device 300 via the second outlet 305a.

With reference to FIG. 6, the heat exchanger 109 of the first embodiment is illustrated. The flow path 111 with flow F fluidly connects the first inlet 104a with the second outlet 105b and the counter flow path 112 with counter flow CF fluidly connects the second inlet 104b with the first outlet 105a. The heat exchanger 109 comprises a methane oxidation unit comprising a chamber for catalytic oxidation of methane. The chamber 314 is located substantially equidistant the length of the flow path 111 and the counter flow path 112.

In use, methane emissions enter the heat exchanger 109 via the first inlet 104a and the second inlet 104b at an emission temperature which is lower than the required temperature for oxidation of methane. The emissions then flow along their respective flow paths 111,112 and enter the chamber 114 wherein catalytic oxidation of methane occurs. The reaction inside the chamber 114 to oxidise the methane emissions is exothermic such that the oxidised emissions exiting the chamber 114 exit at a high temperature of up to 500° C.

The oxidised emissions then exit the chamber 114 and flow along their respective flow paths 111,112 to the first outlet 105a and second outlet 105b, where the oxidised emissions exit the methane oxidation device 100. It is advantageous to emit the oxidised emissions from a device at a temperature significantly lower than the temperature of fluid exiting the chamber 114. High temperature emissions can be dangerous for both the animal wearing the device 100 and any animals, persons or objects proximate the device 100. In this way, there is benefit in recovering and reusing heat from the oxidation process, not only to improve the energy efficiency of the device 100 but also to reduce the dangers from the high temperature oxidised emissions released.

In use, fluid flows via the flow path 111 and the counter flow path 112 and heat from the fluid exiting the methane oxidation unit is transferred to heat the fluid entering said methane oxidation unit. As illustrated in the flow path 111 of FIG. 6, heat from the fluid exiting the chamber 114 and flowing towards the second outlet 105b is transferred to the fluid in the counter flow path 112 which is flowing towards the chamber 114. Additionally, in the counter flow path 112, heat from the fluid exiting the chamber 114 and flowing towards the first outlet 105a is transferred to the fluid in the flow path 111 which is flowing towards the chamber 114. The heat is transferred from the fluid which has undergone oxidation, cooling it, and allowing it to be exhausted from the device 100 at a suitable temperature.

In this way, the device 100 benefits from reducing or removing the requirement to heat the cattle exhalations prior to undergoing a catalytic oxidation reaction in the chamber 114 to remove the exhaled livestock methane. Not only does the device 100 benefit from harvesting the energy from the oxidation reactions to keep the catalyst chamber 114 at a desired temperature such that methane oxidation can occur, but fluid exiting the chamber 114 transfers its undesirable heat from the fluid prior to exiting the device 100 at a safe temperature.

The means of temperature transfer within the heat exchanger 109 is not particularly limited, for example, the heat exchanger 109 may be a shell and tube, plate, plate-fin, printed circuit, film cooling or other suitable heat exchanger. Many of these heat exchangers 109 allow, in use, the fluids with each flow path to transfer heat between them through a wall. It is preferable that heat transfer between the flow path 111 and counter flow path 112, and vice versa, is configured such the heat losses within the heat exchanger 109 are minimised. Further, it is preferable that heat is transferred between the flow path 111 and counter flow path 112 via means which reduce the requirement on external means to assist heat transfer, such as via conduction and/or convection.

The device 100 is configured to minimise heat and pressure losses throughout the device. In this way, the device 100 benefits from increased efficiency, reduced reliance on external energy inputs, such as batteries, and can thus be substantially self-sustaining.

The device 100 is configured for mounting directly on the cow 101 via the positioning means 103 such that the device is wearable and portable. Recovering and reusing heat from the oxidation process reduces the battery requirement for the device 100. However, the device 100 may also be configured as a stationary system, for example by mounting the device 100 in a barn or proximate a feedlot or other exiting structure. The device 100 can be configured to collect methane emissions from the external environment via the methane collection unit. In this way, the device 100 is configured to oxidise methane emissions from a plurality of animals simultaneously. In such a configuration, recovering and reusing heat from the oxidation process reduces the electricity requirements of the device 100.

Further embodiments within the scope of the present invention may be envisaged that have not been described above. For example, in further embodiments of the present invention, it is envisaged that the heat exchanger 109 may comprise a double pass heat exchanger. In particular embodiments of this, this is achieved wherein the connection means fluidly connects the first outlet 105a with the second inlet 104b. In such embodiments, the methane oxidation device 100 is arranged to reduce pressure losses in the device 100 such as by reducing the length of the path travelled by the fluid in the connection means, thus increasing the heat transfer efficiency of the device 100.

In selected embodiments of the present invention, the methane oxidation device 100 comprises for example a pump, such as a centrifugal pump, for assisting fluid flow through the flow path and counter flow path.

It is envisaged in some embodiments of the invention that the methane oxidation device is configured to be mounted to existing positioning means. Additionally, or alternatively, it is envisaged that the methane oxidation device is configured to be in fluid communication with an external methane collection unit, in use. In this way, the methane oxidation device is configured to be fitted to existing apparatus owned by the user.

The materials of the device must be suitable for mounting on an animal, such as being material suitable for outdoor exposure. The heat exchanger is constructed in any a suitable material, for example but not limited to stainless steel or aluminium, through the use of standard mass production techniques including but not limited to die-cutting, welding, diffusion bonding, gasketing and mechanical fastening. The invention is not limited to the specific examples or structures illustrated, a greater number of components than are illustrated in the Figures could be used, for example.

As may be recognized by those of ordinary skill in the art based on the teachings herein, numerous changes and modifications may be made to the above-described and other embodiments of the present disclosure without departing from the scope of the disclosure. The methane oxidation unit for oxidising the methane and the heat exchanger for recovering heat for re-use in oxidation and other components of the methane oxidation device as disclosed in the specification, including the accompanying abstract and drawings, may be replaced by alternative component(s) or feature(s), such as those disclosed in another embodiment, which serve the same, equivalent or similar purpose as known by those skilled in the art to achieve the same, equivalent or similar results by such alternative component(s) or feature(s) to provide a similar function for the intended purpose. In addition, the implants and systems may include more or fewer components or features than the embodiments as described and illustrated herein. Accordingly, this detailed description of the currently-preferred embodiments is to be taken in an illustrative, as opposed to limiting of the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The disclosure has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations

What is claimed is:

1. A methane oxidation device for recovering heat for re-use in oxidation, said methane oxidation device comprising;
a methane oxidation unit for oxidising methane; and
a heat exchanger for recovering heat for re-use in oxidation;
wherein said heat exchanger comprises;
an inlet arranged, in use, in fluid communication with a source of methane emissions;
an outlet;
at least one flow path, said at least one flow path fluidly connecting said inlet to said outlet, said at least one flow path having at least a portion passing though said methane oxidation unit; and
at least one counter flow path, wherein said counter flow path is the counter of said flow path, said at least one counter flow path having at least a portion passing though said methane oxidation unit;
in use, the at least one flow path and counter flow path are arranged to permit heat transfer therebetween.

2. The device of claim 1, wherein, in use, fluid flows via said at least one flow path and said at least one counter flow path and heat from the fluid exiting the methane oxidation unit is transferred to heat the fluid entering said methane oxidation unit.

3. The device of claim 1, wherein said heat exchanger is a recuperative heat exchanger.

4. The device of claim 1, wherein said heat exchanger is a regenerative heat exchanger.

5. The device of claim 1, wherein said heat exchanger is a single pass heat exchanger.

6. The device of claim 1, wherein said inlet comprises an inlet manifold and said outlet comprises an outlet manifold.

7. The device of claim 1, wherein said at least one counter flow path is parallel to said at least one flow path.

8. The device of claim 1, wherein the length of said at least one flow path is identical to the length of said at least one counter flow path.

9. The device of claim 1, wherein said at least one flow path and said at least one counter flow path are substantially straight.

10. The device of claim 1, wherein said at least one flow path and said at least one counter flow path are at least one of substantially curved or U-shaped.

11. The device of claim 1, wherein said methane oxidation unit comprises a chamber for catalytic oxidation of methane.

12. The device of claim 10, wherein said methane oxidation unit comprises at least one catalytic material located within said heat exchanger.

13. The device of claim 12, wherein said at least one catalytic material is located within at least one of said at least one flow path or said at least one counter flow path.

14. The device of claim 1, wherein said methane oxidation unit is located substantially equidistant the length of said at least one flow path and said at least one counter flow path.

15. The device of claim 1, wherein said heat exchanger comprises an insulation unit for insulating the device to reduce heat loss to the external environment.

16. The device of claim 1, wherein said device comprises a plurality of heat exchangers.

17. The device of claim 16, wherein said device further comprises a heater unit for heating fluid within the methane oxidation unit while in use.

18. The device of claim 17, wherein said device is substantially cuboid.

19. The device of claim 17, wherein said device is substantially V-shaped.

20. The device of claim 1, wherein said device further comprises a connection means for connecting said inlet to a methane collection unit.

21. The device of claim 1, wherein said device further comprises a methane collection unit for collecting methane emissions emitted by an animal.

22. The device of claim 1, wherein said device further comprises positioning means for positioning said device proximate the head of an animal.

23. The device of claim 1, wherein said device further comprises at least one sensor.

24. The device of claim 1, wherein said device further comprises a pump for assisting fluid flow through the device while in use.

25. The device of claim 1, wherein said device further comprises an emission separator unit for separating the emissions based on at least one emission characteristic while in use.
